(19) United States
(12) Patent Application Publication
(10) Pub. No.: US 2016/0356608 A1
(43) Pub. Date: Dec. 8, 2016

(54) MAP-MATCHING BY DUAL-LEVEL HEURISTIC SEARCH

(71) Applicant: International Business Machines Corporation, Armonk, NY (US)

(72) Inventors: Wei Shan Dong, Beijing (CN); Ning Duan, Beijing (CN); Peng Gao, Beijing (CN); Chun Yang Ma, Beijing (CN); Xin Zhang, Beijing (CN)

(21) Appl. No.: 14/731,529

(22) Filed: Jun. 5, 2015

(51) Int. Cl. G01C 21/30; G01S 19/42

(52) U.S. Cl. CPC G01C 21/30; G01S 19/42

(57) ABSTRACT

In one embodiment, a computer-implemented method includes receiving a global positioning system (GPS) location of a mobile device. Two or more road locations are determined as possible locations corresponding to the GPS location in a physical network of a set of roads. A first portion of a virtual network is built, by a computer processor, by expanding the virtual network from a node representing a prior road location to the two or more candidate road locations. A first candidate road location is selected as a current road location from among the two or more candidate road locations. A route of the mobile device is identified as including the prior road location and the first candidate road location. At least one of the two or more candidate road locations not selected as the current road location is excluded from future building of the virtual network. The virtual network is built dynamically.

### BACKGROUND

Various embodiments of this disclosure relate to map-matching and, more particularly, to map-matching by dual-level heuristic search.

Location-based services are becoming more and more popular. However, the readings of a global positioning system (GPS) sensor have positioning and sampling errors, and thus, a departure of the GPS tracking data from an actual trajectory of a GPS device is likely. As a result, the task of map-matching is a prerequisite for providing LBS in a connected vehicle. Generally, map-matching involves matching original GPS tracking data to a digital map while handling exceptions, correcting errors, reducing noise and redundancy.

### SUMMARY

In one embodiment of this disclosure, a computer-implemented method includes receiving a global positioning system (GPS) location of a mobile device. Two or more road locations are determined as possible locations corresponding to the GPS location in a physical network of a set of roads. A first portion of a virtual network is built, by a computer processor, by expanding the virtual network from a node representing a prior road location to the two or more candidate road locations. A first candidate road location is selected as a current road location from among the two or more candidate road locations. A route of the mobile device is identified as including the prior road location and the first candidate road location. At least one of the two or more candidate road locations not selected as the current road location is excluded from future building of the virtual network, where the virtual network is built dynamically.

In another embodiment, a system includes a memory and one or more computer processors communicatively coupled to the memory. The one or more computer processors are configured to receive a GPS location of a mobile device, and to determine two or more road locations as possible locations corresponding to the GPS location in a physical network of a set of roads. The one or more computer processors are further configured to build a first portion of a virtual network by expanding the virtual network from a node representing a prior road location to the two or more candidate road locations. The one or more computer processors are further configured to select as a current road location a first candidate road location from among the two or more candidate road locations, and to identify a route of the mobile device as including the prior road location and the first candidate road location. The one or more computer processors are further configured to exclude from future building of the virtual network at least one of the two or more candidate road locations not selected as the current road location, where the virtual network is built dynamically.

In yet another embodiment, a computer program product for map-matching includes a computer readable storage medium having program instructions embodied therewith. The program instructions are executable by a processor to cause the processor to perform a method. The method includes receiving a GPS location of a mobile device. Further according to the method, two or more road locations are determined as possible locations corresponding to the GPS location in a physical network of a set of roads. A first portion of a virtual network is built by expanding the virtual network from a node representing a prior road location to the two or more candidate road locations. A first candidate road location is selected as a current road location from among the two or more candidate road locations. A route of the mobile device is identified as including the prior road location and the first candidate road location. At least one of the two or more candidate road locations not selected as the current road location is excluded from future building of the virtual network, where the virtual network is built dynamically.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a mapping system, according to some embodiments of this disclosure;

FIG. 2 is another block diagram of the mapping system, according to some embodiments of this disclosure;

FIG. 3 is a diagram of an example virtual network for map-matching, according to some embodiments of this disclosure;

FIG. 4 is a flow diagram of a method for map-matching according to some embodiments of this disclosure; and

FIG. 5 is a block diagram of a computing device for implementing some or all aspects of the mapping system, according to some embodiments of this disclosure.

### DETAILED DESCRIPTION

Various embodiments of this disclosure provide map-matching for matching GPS data with digital maps. In other words, given global positioning system (GPS) data and a digital map, an embodiment may determine a trajectory or location of a mobile device on the digital map.

Existing match-mapping algorithms have numerous drawbacks. For instance, some are incremental, in that they match only a small portion of the trajectory. Thus, when matching a new position, these algorithms consider only the previously determined position. Although fast, methods using these algorithms are sensitive to decreases in sampling frequency. Some algorithms consider the entire trajectory, but they do so at a higher computational cost. Additionally, these algorithms tend to employ only spatial analysis, while neglecting temporal and speed constraints of trajectories. Some algorithms use statistical approaches, which are particularly effective for handling GPS measurement errors, but are also high in computational cost. Existing mainstream algorithms, such as Hidden Markov Map-Matching and Interactive Voting Based Map-Matching, are based on transition probability calculation. Without spatial heuristics, these algorithms need to calculate all possible transition probabilities between any two adjacent GPS locations. In contrast to these, some embodiments of this disclosure may provide a high availability and low latency map-matching solution. Thus, some embodiments can have a lower computational cost (e.g., approximately 3-6 times lower) than execution of existing algorithms.

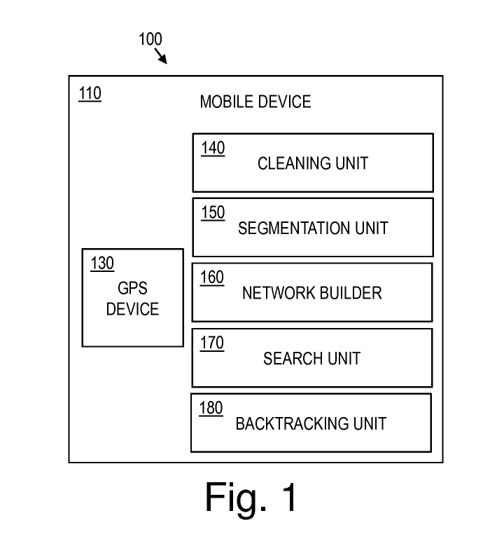

FIG. 1 is a block diagram of a mapping system 100, according to some embodiments of this disclosure, where the mapping system 100 is configured to match GPS data to a digital map. As shown, the mapping system 100 may operate, at least in part, on a mobile device 110, such as a mobile phone or a vehicle. The mapping system 100 may include a cleaning unit 140, a segmentation unit 150, a network builder 160, a search unit 170, and a backtracking unit 180, each of which may include hardware, software, or a combination of both. Although these units 140, 150, 160, 170, 180 are illustrated as being distinct components, it will be understood that this distinction is for illustrative purposes only, and these components may share hardware, software, or both, or they may be further divided. Generally, the cleaning unit 140 may clean GPS data received from a GPS device; the segmentation unit 150 may segment the GPS data into windows for analysis; the network builder 160 may build a virtual network representing potential locations of the mobile device 110 in a physical network; the search unit 170 may perform a dual-level heuristic search on the virtual network; and the backtracking unit 180 may backtrack through the virtual network as needed.

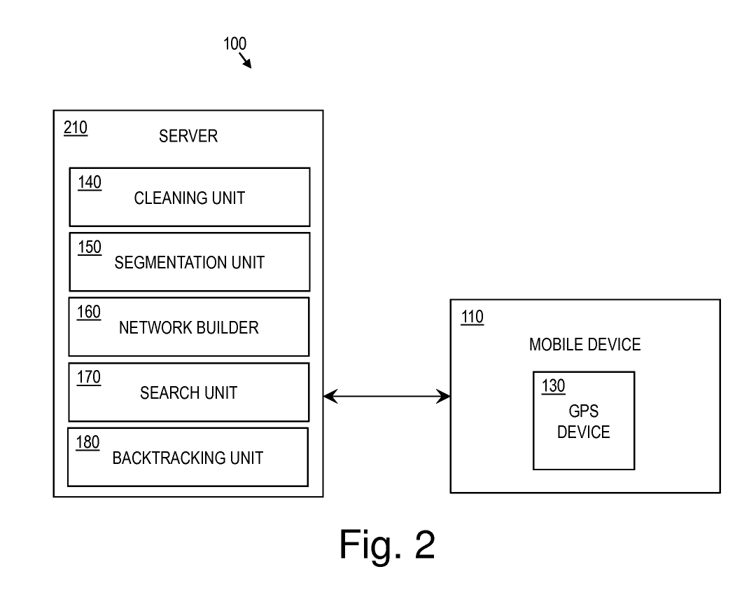

FIG. 2 is another block diagram of the mapping system 100, according to some embodiments. As shown, the mapping system 100 need not reside entirely on the mobile device 110. Rather, on some embodiments, the mobile device 110 may be in communication with a server 210, which may perform some or all analyses and communicate the resulting route to the mobile device 110.

The mobile device 110 may include a GPS device 130 configured to provide GPS data. The mobile device 110 may be, for example, a mobile phone or a vehicle with a navigation system. The mapping system 100 may clean this GPS data, which may be performed by the cleaning unit 140 in some embodiments. Cleaning the GPS data may include, for example, removing data points that are outliers and removing redundant data points. Various mechanisms exist for cleaning GPS data, and one or more of these may be used by the mapping system 100.

To reduce computational cost, the mapping system 100 may evaluate only a segment, or window, of the GPS data at a given time. In some embodiments, this segmenting may be performed by the segmentation unit 150. Each segment may be defined in various ways. For example, a segment may include GPS data received within a fixed time period, or may include a fixed number of GPS coordinates. Various mechanisms exist in the art for segmenting GPS data for the purpose of map-matching, and one or more of these may be used by the mapping system 100.

Generally, a GPS device may report a location A for a mobile device 110, such as a vehicle. In reality, however, this GPS location is not precise, and GPS location A likely does not coincide precisely with an actual road location on the map. The mapping system 100 may project GPS location A to one or more road locations on the digital map, which may be the closest locations on each road adjacent to the GPS location. Thus, each GPS location may correspond to one or more candidate road locations where the mobile device 110 may actually be located. In this example, GPS location A corresponds to road locations A₁, A₂, and A₃; GPS location B corresponds to road locations B₁ and B₂; and GPS location C corresponds to road locations C₁, C₂, and C₃. Generally, the mapping system 100 may seek to identify which candidate road locations are actual road locations of the mobile device 110.

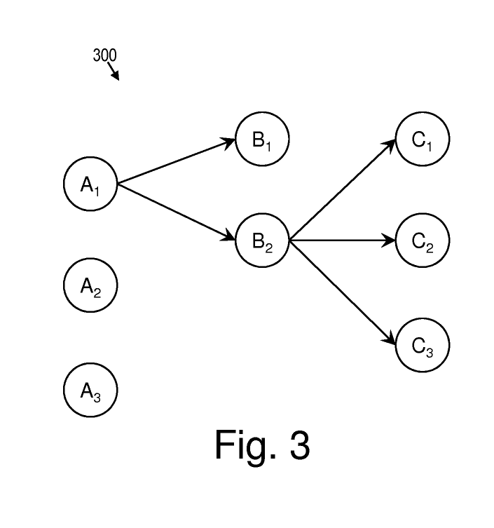

FIG. 3 is a virtual network 300 that may be built based on the GPS locations and candidate road locations of the above example, according to some embodiments. The mapping system 100, such as by way of the network builder 160, may build such a virtual network 300. In the virtual network 300, each node 210 may represent a candidate road location corresponding to a received GPS location. For example, road locations A₁, A₂, and A₃ may each be represented by nodes corresponding to GPS location A. As will be discussed below, the virtual network 300 may be built dynamically, while a dual-level heuristic search is performed. This search may be performed, in some embodiments, by the search unit 170.

Given a set of candidate road locations for a GPS location, the mapping system 100 may apply a cost function, or a penalty function, to each candidate road location to determine which of the candidates has the lowest cost or, if applicable, the highest cost. The cost function may vary between implementations. For example, and not by way of limitation, the cost function may consider one or more of the following: GPS error, popularity of candidate road location, road network connectivity and accessibility (i.e., ease of getting to the candidate road location from a prior road location), length of path from the prior road location, driving directions (i.e., how close the candidate road location is to a route provided by a navigation system or other location-based service), and velocity match (i.e., correspondence between approximate velocity and distance between the candidate road location and the prior road location). In some embodiments, the cost function may be a probability function, and in that case, the costs of all candidate road locations within the set may sum to approximately a value of 1. Further, in that case, the mapping system 100 may select the candidate road location with the highest cost. By using the cost function, the mapping system 100 may incorporate a spatial search that eliminates unlikely road location candidates, thus reducing the complexity of the map-matching problem.

At a given time, the mapping system 100 may have access to a prior road location, which may be the road location selected from among the candidate road locations corresponding to a previous GPS location, as well as a set of candidate road locations for a current GPS location. Throughout this disclosure, the term “current” with respect to road locations, GPS locations, and time may refer to locations and times currently being considered, and not necessarily to a real-time situations of a mobile device 110. For instance, in some embodiments, some or all GPS locations of a route may be received before analysis by the mapping system 100 begins, in which case a current GPS location may refer to data relating to a position previously held by the mobile device 110. When initiating map-matching for a new route, no prior road location (i.e., prior to the current road location) may exist for the new route. In that case, the mapping system 100 may apply the cost function to a set of candidate road locations for an initial GPS location, so as to select an initial road location. Analysis of a following GPS location may then proceed with the initial road location set as its prior road location.

The mapping system 100 may perform a dual-level heuristic search, which may include searching the virtual network 300 as well as searching the physical network of actual roads and their connections. Searching the virtual network 300 may include generating edges between nodes to indicate possible routes, or virtual connections. In contrast, searching the physical network may include applying the cost function, which may encapsulate various features of the physical network.

In the virtual network 300, the mapping system 100 may generate an edge between the prior road location and each candidate road location for a current GPS location. The mapping system 100 may apply the cost function to each node representing a candidate road location adjacent to these new edges, and may thus select the node with the lowest cost, which represents the candidate road location with the lowest cost. This candidate road location may be selected as the current road location of the mobile device 110. It will be understood, however, that in some embodiments, the node and candidate road location with the highest cost may be selected instead of the node and candidate road location with the lowest cost, depending on the implementation of the cost function. The mapping system 100 may thus decide the mobile device's route leads from the prior road location to the selected road location represented by the selected node. When the next GPS location is analyzed, the selected road location may act as the prior road location.

It will be understood that the cost function may be applied to edges in the virtual network 300 rather than nodes. In that case, instead of a cost being applied to a first node representing a candidate road location, that same cost may be applied to the edge leading to the first node from the node representing the prior road location.

The virtual network 300 may be built dynamically, with edges being generated from a node after that node is selected as a current road location. The mapping system 100 need not generate edges expanding from candidate road locations that are not selected. Thus, as a result, calculations related to certain routes may be avoided. For instance, given the above example with GPS locations A, B, and C, FIG. 3 illustrates the virtual network 300 that may be built when road locations A₁ and B₂ are selected as current road locations. In this case, the nodes corresponding to road locations A₂, A₃, and B₁ need not be expanded, and thus, the cost function need not be applied to potential routes stemming from these nodes.

The mapping system 100 may be configured to backtrack through the virtual network 300 in certain circumstances. In some embodiments, this backtracking may be performed by the backtracking unit 180. Backtracking may include selecting a node representing a candidate road location that was previously not selected in favor of an alternate candidate road location for the same GPS location. In the case of backtracking to a particular candidate road location, that particular candidate road location may be selected, and then the set of candidate road locations for each GPS location following the newly selected candidate road location may be re-analyzed. Thus, the mapping system 100 may select a new route through the virtual network 300 and a corresponding new route through the physical network.

The mapping system 100 may backtrack under various circumstances including, for example, the cost function providing too-high values for a current set of candidate road locations, or all candidate road locations in the current set being unreachable from the prior road locations. A value of the cost function may be deemed too high if it exceeds a selection threshold chosen to indicate an unlikelihood of taking the route in question. In other words, for a candidate road location to be selected, it may be required to meet certain selection criteria, such as its cost function value being below the selection threshold. If no such candidate road location is identified among the current set of candidate road locations, the mapping system 100 may backtrack.

When a decision to backtrack is made, the mapping system 100 may go back at least one level in the virtual network 300. For example, the mapping system 100 may go back one level, to reevaluate the selection of the prior road location. If no other candidate road location corresponding to the GPS location of the prior road location meets the selection criteria, the mapping system 100 may backtrack another level. The mapping system 100 may continue to backtrack until a candidate road location meeting the selection criteria is found. When one is found, the mapping system 100 may select the candidate road location with the highest value of the cost function from among that set of candidate road locations. That selected candidate road location may then be expanded toward the following set of candidate road locations, and the mapping system 100 may continue building the virtual network 300 up until the nodes representing the current set of candidate road locations. From there, the mapping system 100 may proceed as usual.

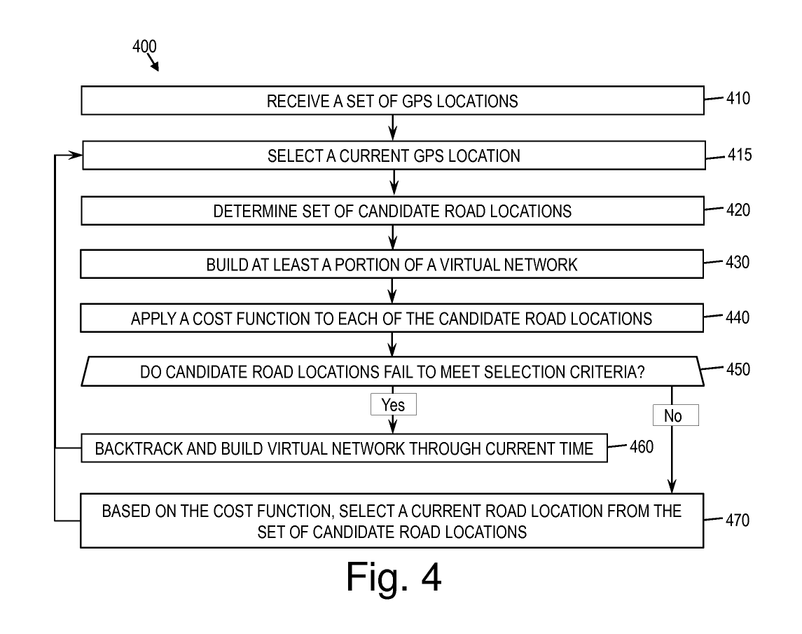

FIG. 4 is a flow diagram of a method 400 for map-matching, according to some embodiments of this disclosure. As shown, at block 410, a set of GPS locations may be received. At block 415, a current GPS location may be selected for consideration from among the received GPS locations. At block 420, a set of candidate road locations may be determined from the GPS location. At block 430, at least a portion of a virtual network 300 may be built based on the GPS location and the candidate road locations. Due to the dynamic nature of the virtual network 300, the mapping system 100 need not build the entire virtual network 300. At block 440, a cost function may be applied to the current set of candidate road locations. Together, blocks 430 and 440 may provide a dual-level heuristic search. At decision block 450, it may be determined whether the candidates in the current set of candidate road locations all fail to meet the selection criteria. If so, then at block 460, backtracking may be performed until a candidate road location is identified that meets the selection criteria, and the mapping system 100 may build the virtual network 300 through the current time. The method 400 may then return to block 410 to receive a new GPS location. However, if not all candidate road locations fail, then at block 470, a current candidate road location may be selected from among the set of candidate road locations, based on the cost function. For example, the candidate road location with the lowest value of the cost function may be selected. The method 400 may then proceed to block 415 to consider a new GPS location following the current GPS location.

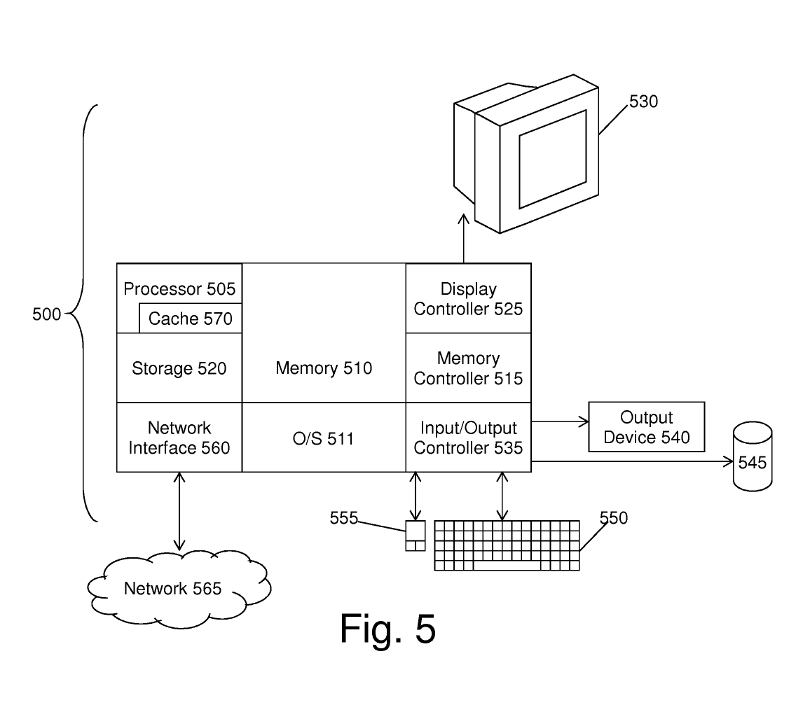

FIG. 5 illustrates a block diagram of a computer system 500 for use in implementing a mapping system or method according to some embodiments. The mapping systems and methods described herein may be implemented in hardware, software (e.g., firmware), or a combination thereof. In some embodiments, the methods described may be implemented, at least in part, in hardware and may be part of the microprocessor of a special or general-purpose computer system 500, such as a personal computer, workstation, minicomputer, or mainframe computer.

In some embodiments, as shown in FIG. 5, the computer system 500 includes a processor 505, memory 510 coupled to a memory controller 515, and one or more input devices 545 and/or output devices 540, such as peripherals, that are communicatively coupled via a local I/O controller 535. These devices 540 and 545 may include, for example, a printer, a scanner, a microphone, and the like. Input devices such as a conventional keyboard 550 and mouse 555 may be coupled to the I/O controller 535. The I/O controller 535 may be, for example, one or more buses or other wired or wireless connections, as are known in the art. The I/O controller 535 may have additional elements, which are omitted for simplicity, such as controllers, buffers (caches), drivers, repeaters, and receivers, to enable communications.

The I/O devices 540, 545 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 505 is a hardware device for executing hardware instructions or software, particularly those stored in memory 510. The processor 505 may be a custom made or commercially available processor, a central processing unit (CPU), an auxiliary processor among several processors associated with the computer system 500, a semiconductor based microprocessor (in the form of a microchip or chip set), a macroprocessor, or other device for executing instructions. The processor 505 includes a cache 570, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 570 may be organized as a hierarchy of more cache levels (L1, L2, etc.).

The memory 510 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 510 may incorporate electronic, magnetic, optical, or other types of storage media. Note that the memory 510 may have a distributed architecture, where various components are situated remote from one another but may be accessed by the processor 505.

The instructions in memory 510 may include one or more separate programs, each of which comprises an ordered listing of executable instructions for implementing logical functions. In the example of FIG. 5, the instructions in the memory 510 include a suitable operating system (OS) 511. The operating system 511 essentially may control the execution of other computer programs and provides scheduling, input-output control, file and data management, memory management, and communication control and related services.

Additional data, including, for example, instructions for the processor 505 or other retrievable information, may be stored in storage 520, which may be a storage device such as a hard disk drive or solid state drive. The stored instructions in memory 510 or in storage 520 may include those enabling the processor to execute one or more aspects of the mapping systems and methods of this disclosure.

The computer system 500 may further include a display controller 525 coupled to a display 530. In some embodiments, the computer system 500 may further include a network interface 560 for coupling to a network 565. The network 565 may be an IP-based network for communication between the computer system 500 and an external server, client and the like via a broadband connection. The network 565 transmits and receives data between the computer system 500 and external systems. In some embodiments, the network 565 may be a managed IP network administered by a service provider. The network 565 may be implemented in a wireless fashion, e.g., using wireless protocols and technologies, such as WiFi, WiMax, etc. The network 565 may also be a packet-switched network such as a local area network, wide area network, metropolitan area network, the Internet, or other similar type of network environment. The network 565 may be a fixed wireless network, a wireless local area network (LAN), a wireless wide area network (WAN) a personal area network (PAN), a virtual private network (VPN), intranet or other suitable network system and may include equipment for receiving and transmitting signals.

Mapping systems and methods according to this disclosure may be embodied, in whole or in part, in computer program products or in computer systems 500, such as that illustrated in FIG. 5.

Technical effects and benefits of some embodiments include the ability to use a dual-level heuristic search to match GPS data with a digital map, with high availability and low latency. As a result, location-based services may be provided in an efficient manner.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving a global positioning system (GPS) location of a mobile device;
determining two or more road locations as possible locations corresponding to the GPS location in a physical network of a set of roads;
building, by a computer processor, a first portion of a virtual network by expanding the virtual network from a node representing a prior road location to the two or more candidate road locations;
selecting as a current road location a first candidate road location from among the two or more candidate road locations;
identifying a route of the mobile device as including the prior road location and the first candidate road location; and
excluding from future building of the virtual network at least one of the two or more candidate road locations not selected as the current road location, wherein the virtual network is built dynamically.

2. The method of claim 1, wherein each node in the virtual network represents a corresponding candidate road location, and wherein a path through the virtual network represents the route of the mobile device through the physical network.

3. The method of claim 1, wherein selecting as the current road location the first candidate road location comprises applying a cost function to each of the two or more candidate road locations.

4. The method of claim 3, wherein the cost function considers one or more spatial constraints of the physical network of the set of roads.

5. The method of claim 1, wherein the building and the selecting comprise performing a dual-level heuristic search.

6. The method of claim 1, further comprising backtracking through the virtual network to change the selection of the first candidate road location, responsive to selection criteria not being met for a later set of candidate road locations.

7. The method of claim 6, wherein the selection criteria require that a value of the cost function exceed a selection threshold.

8. A system comprising:
a memory; and
one or more computer processors, communicatively coupled to the memory, the one or more processors configured to:
receive a global positioning system (GPS) location of a mobile device;
determine two or more road locations as possible locations corresponding to the GPS location in a physical network of a set of roads;
build a first portion of a virtual network by expanding the virtual network from a node representing a prior road location to the two or more candidate road locations;
select as a current road location a first candidate road location from among the two or more candidate road locations;
identify a route of the mobile device as including the prior road location and the first candidate road location; and
exclude from future building of the virtual network at least one of the two or more candidate road locations not selected as the current road location, wherein the virtual network is built dynamically.

9. The system of claim 8, wherein each node in the virtual network represents a corresponding candidate road location, and wherein a path through the virtual network represents the route of the mobile device through the physical network.

10. The system of claim 8, wherein, to select as the current road location the first candidate road location, the one or more computer processors are further configured to apply a cost function to each of the two or more candidate road locations.

11. The system of claim 10, wherein the cost function considers one or more spatial constraints of the physical network of the set of roads.

12. The system of claim 8, wherein, to perform the build and the select, the one or more computer processors are further configured to perform a dual-level heuristic search.

13. The system of claim 8, wherein the one or more computer processors are further configured to backtrack through the virtual network to change the selection of the first candidate road location, responsive to selection criteria not being met for a later set of candidate road locations.

14. The system of claim 13, wherein the selection criteria require that a value of the cost function exceed a selection threshold.

15. A computer program product for map-matching, the computer program product comprising a computer readable storage medium having program instructions embodied therewith, the program instructions executable by a processor to cause the processor to perform a method comprising:
receiving a global positioning system (GPS) location of a mobile device;
determining two or more road locations as possible locations corresponding to the GPS location in a physical network of a set of roads;
building a first portion of a virtual network by expanding the virtual network from a node representing a prior road location to the two or more candidate road locations;
selecting as a current road location a first candidate road location from among the two or more candidate road locations;
identifying a route of the mobile device as including the prior road location and the first candidate road location; and
excluding from future building of the virtual network at least one of the two or more candidate road locations not selected as the current road location, wherein the virtual network is built dynamically.

16. The computer program product of claim 15, wherein each node in the virtual network represents a corresponding candidate road location, and wherein a path through the virtual network represents a route of the mobile device through the physical network.

17. The computer program product of claim 15, wherein selecting as the current road location the first candidate road location comprises applying a cost function to each of the two or more candidate road locations, wherein the cost function considers one or more spatial constraints of the physical network of the set of roads.

18. The computer program product of claim 15, wherein the building and the selecting comprise performing a dual-level heuristic search.

19. The computer program product of claim 15, the method further comprising backtracking through the virtual network to change the selection of the first candidate road location, responsive to selection criteria not being met for a later set of candidate road locations.

20. The computer program product of claim 19, wherein the selection criteria require that a value of the cost function exceed a selection threshold.
